(19) United States
(12) Patent Application Publication
(10) Pub. No.: US 2019/0272598 A1
(43) Pub. Date: Sep. 5, 2019

(54) CEPHALOPOD FISHERY FORECASTING METHOD IN NORTHWEST AFRICAN WATERS BASED ON ENVIRONMENTAL FACTORS

(71) Applicant: SHANGHAI OCEAN UNIVERSITY, Shanghai (CN)

(72) Inventors: Xinjun CHEN, Shanghai (CN); Zhong ZHANG, Shanghai (CN); Ji Peng WEI, Shanghai (CN); Jin Tao WANG, Shanghai (CN); Lin LEI, Shanghai (CN)

(73) Assignee: SHANGHAI OCEAN UNIVERSITY, Shanghai (CN)

(21) Appl. No.: 16/334,026

(22) PCT Filed: Aug. 17, 2018
(86) PCT No.: PCT/CN2018/101111

§ 371 Date: Mar. 18, 2019

(30) Foreign Application Priority Data
Aug. 29, 2017 (CN) 201710756994.3
Aug. 29, 2017 (CN) 201710757632.6

(51) Int. Cl. G06Q 50/02; G06Q 10/04; A01K 61/10

(52) U.S. Cl. CPC G06Q 50/02; A01K 61/10; G06Q 10/04

(57) ABSTRACT

A cephalopod fishery forecasting method in northwest African waters based on environmental factors, including the following steps: step 1: acquiring catch production statistical data from cephalopod fisheries in northwest African waters of many years; step 2: acquiring marine environmental data corresponding to the catch production statistical data, the marine environmental data including sea surface temperature (SST) and sea surface height anomaly (SSHA); step 3: studying the relationship between the operating haul, the operating output ratio and the average output per haul in each interval as indexes of a central fishery and the marine environmental data of step 2; and step 4: establishing suitability indexes (SI) of different environmental factors, and calculating habitat suitability indexes (HSI) under different weight cases by using an expert assignment method, thus obtaining distribution waters of the central fishery of cephalopod fisheries in northwest African waters for forecasting the central fishery.

### CROSS REFERENCE TO THE RELATED APPLICATIONS

This application is the national phase entry of International Application No. PCT/CN2018/101111, filed on Aug. 17, 2018, which claims priority from the Chinese patent application no. 201710757632.6 filed on Aug. 29, 2017 and the Chinese patent application no. 201710756994.3 filed on Aug. 29, 2017, the entire contents of which are incorporated herein by reference.

### TECHNICAL FIELD

The present invention relates to a cephalopod fishery forecasting method in northwest African waters, in particular to a cephalopod fishery forecasting method in northwest African waters based on environmental factors.

### BACKGROUND

Mauritania is a country in the western region of the African continent, with long coastline and unique marine environment, and the fishery is the main source of its national economic income. The marine fishery resource has a storage capacity of more than 400×104t, and is especially rich in cephalopods. The cephalopods are also the main fishing object for Chinese ocean fishing vessels. The studies on cephalopod resources and fisheries in the waters nearby Mauritania are of great significance for efficient production of Chinese offshore trawlers.

Xu Jianguo et al. have explored and improved tools for capturing cephalopods from Mauritania fisheries. Zhang Jinbao believed upon research that the development potential of fishery resources in the Mauritanian waters is 1.511 million tons, where the cephalopods account for 65,000 tons. Zhou Aizhong et al.'s studies show that the cephalopod resources have been excessively exploited in shore of the Mauritanian waters, and the increase in fishing landing amount is increasingly limited. Feng Chunlei et al. investigated the hydrological situation of cephalopod fishery distribution in Mauritania, analyzed the spatial structures and changes of various factors such as water mass, temperature, current and hydrological factors (water temperature, dissolved oxygen, salinity, chlorophyll), and discussed the impact of the marine structure and marine environment of the researched sea area on cephalopod fisheries. It can be known in combination with literatures that Mauritanian cephalopod fisheries and habitat models thereof are seldom researched at home and abroad.

Morocco is in the north of the Atlantic Ocean and the Mediterranean Sea, and is a bridge between the Mediterranean Sea and the Atlantic Ocean. Marine fisheries are a major source of foreign exchange for Morocco and are at a critical position in the development of its domestic economy. Cephalopods have the highest economic benefits among the fishery resources in Morocco. In Morocco, it has been more than 20 years from the first bottom trawl operation of Chinese fishing vessels. However, the main fishing objects of bottom trawls have always been cephalopods such as octopus and squid. Numerous domestic experts have conducted many investigations and discussions on various aspects of Moroccan fishery development, fishing gears and fishing methods, pelagic fish resources in the waters, etc. However, few domestic literatures have studied the distribution of Moroccan cephalopod fisheries.

Due to the abundance of northwestern African waters cephalopod resources and the current status of the fishery, it is necessary to study the distribution and habitat models of cephalopod fisheries, which is also conducive to accurate fishery forecasting. The accurate fishery forecasting can guide enterprises to arrange the fishery production reasonably, shorten the time for searching fisheries, reduce the cost and improve the fishing yield.

### SUMMARY

The technical problem to be solved by the present invention is to provide a cephalopod fishery forecasting method in northwest African waters based on environmental factors, which studies the impact of marine environmental factors and habitat indexes on northwestern African waters cephalopod fisheries, and establishes a fishery forecasting model by studying the marine environmental factors and habitat indexes that have the most significant impact on northwestern African waters cephalopod resources, thereby accurately forecasting the fisheries and improving the fishing yield.

### Technical Solution

A cephalopod fishery forecasting method in northwest African waters based on environmental factors, comprising the following steps:

step 1: acquiring catch production statistical data from cephalopod fisheries in northwest African waters of many years, the catch production statistical data including operating time, operating sea depth, operating haul and total catch output;
step 2: acquiring marine environmental data corresponding to the catch production statistical data, the marine environmental data including sea surface temperature (SST) and sea surface height anomaly (SSHA), based on a monthly time resolution and a 0.5°×0.5° spatial resolution;
step 3: studying the relationship between the operating haul, the operating output ratio and the average output per haul in each interval as indexes of a central fishery and the marine environmental data of step 2; and
step 4: establishing suitability indexes (SI) of different environmental factors, calculating habitat suitability indexes (HSI) under different weight cases by using an expert assignment method, thus obtaining distribution waters of the central fishery of cephalopod fisheries in northwest African waters, and obtaining an optimal weight case in the distribution waters for forecasting the central fishery.

Further, the catch production statistical data from the cephalopod fisheries in northwest African waters is data of 4-6 years.

Further, for Moroccan fisheries in the northwest Africa, marine environmental data corresponding to the catch production statistical data is acquired, the marine environmental data including sea surface temperature (SST), sea surface height anomaly (SSHA) and chlorophyll concentration Chl-a; the operating haul, the operating output ratio and the average output per haul in each interval are calculated using 1° C. as an interval of the SST, and then an optimal SST range of the central fishery is obtained; the operating haul, the operating output ratio and the average output per haul in each interval are calculated using 10 cm as an interval of the SSHA, and then an optimal SSHA range of the central fishery is obtained; the operating haul, the operating output ratio and the average output per haul in each interval are calculated using 0.01-1.0, 1.0-2.0, 2.0-5.0, 5.0-20.0 or 20.0-50.0 mg/m³ as an interval of Chl-a content, and then an optimal Chl-a range of the central fishery is obtained; and the operating haul, the operating output ratio and the average output per haul in each interval are calculated using 10 m as an interval of sea depth, and then an optimal sea depth range of the central fishery is obtained.

Further, suitability indexes (SI) of different environmental factors are established for the marine environmental data including sea surface temperature (SST), sea surface height anomaly (SSHA) and chlorophyll concentration Chl-a, and habitat suitability indexes HSI under different weight cases are calculated using the following formula:

HSI=X_{SST}*I_{SI_SST}+X_{SSHA}*I_{SI_SSHA}+X_{CHL-a}*I_{SI-CHL-a}+X_{DEPTH}*I_{SI_DEPTH}

in which: I_{SI_SST} indicates a suitability index based on sea surface temperature; I_{SI_SSHA} indicates a suitability index based on sea surface height anomaly; I_{SI-CHL-a} indicates a suitability index based on chlorophyll concentration; I_{SI_DEPTH} indicates a suitability index based on sea depth; and X_{SST}, X_{SSHA}, X_{CHL-a} and X_{DEPTH} indicate weight values of sea surface temperature, sea surface height anomaly, chlorophyll concentration and sea depth respectively.

Further, waters with the highest operating haul are set as waters with the highest distribution probability of the central fishery, and the suitability index SI is assigned with 1; when there is no operating haul, the suitability index SI is assigned with 0; when the operating haul is higher than the average, the suitability index SI is assigned with 0.5; and when the operating haul is lower than the average, the suitability index SI is assigned with 0.1.

Further, the following five weight cases are used for the weight values of sea surface temperature, sea surface height anomaly, chlorophyll concentration and sea depth:

Case 1: X_{SST} is 0.25, X_{SSHA} is 0.25, X_{CHL-a} is 0.25, and X_{DEPTH} is 0.25;
Case 2: X_{SST} is 0, X_{SSHA} is 0.9, X_{CHL-a} is 0, and X_{DEPTH} is 0.1;
Case 3: X_{SST} is 0.1, X_{SSHA} is 0.1, X_{CHL-a} is 0, and X_{DEPTH} is 0.8;
Case 4: X_{SST} is 0.9, X_{SSHA} is 0.1, X_{CHL-a} is 0, and X_{DEPTH} is 0;
Case 5: X_{SST} is 0.4, X_{SSHA} is 0.4, X_{CHL-a} is 0.1, and X_{DEPTH} is 0.1;
an optimal weight case for forecasting the central fishery of the Moroccan cephalopod fisheries is obtained by comparing the HSI values in the five different weight cases with a set threshold respectively.

Further, statistics on monthly total catch haul, total output and days are collected for Moroccan fisheries in the northwest Africa based on SST minimum 15° C., SSHA minimum −45 cm, sea depth minimum 15 m and corresponding intervals 1° C., 10 cm and 10 m, then a catch haul ratio, an output ratio and an average output per haul at intervals of SST 1° C., SSHA 10 cm and sea depth 10 m are solved, and an optimal sea surface temperature interval, an optimal sea surface height anomaly interval and an optimal sea depth interval of the central fishery in each month are thus obtained. Further, the habitat suitability indexes HSI under different weight cases are calculated for the corresponding marine environmental data by adopting the following formula:

HSI=X_{SST}*I_{SI_SST}+X_{SSHA}*I_{SI_SSHA}+X_{DEPTH}*I_{SI_DEPTH};

in which: I_{SI_SST} indicates a suitability index based on sea surface temperature; I_{SI_SSHA} indicates a suitability index based on sea surface height anomaly; I_{SI_DEPTH} indicates a suitability index based on sea depth; X_{SST}, X_{SSHA} and X_{DEPTH} indicate weight values of sea surface temperature, sea surface height anomaly and sea depth respectively.

Further, based on a frequency distribution map of the operating haul, the suitability indexes SI of different environmental factors are established, the values of the suitability indexes SI are assigned using an expert assignment method, the maximum operating haul NETmax is set in waters with the highest catch distribution probability, and the suitability index SI is assigned with 1; when there is no operating haul, the suitability index SI is assigned with 0; when the operating haul is higher than the average, the suitability index SI is assigned with 0.5; and when the operating haul is lower than the average, the suitability index SI is assigned with 0.1.

Further, the following five weight cases are used for the weight values of sea surface temperature, sea surface height anomaly and sea depth:

Case 1: X_{SST} is 0.6, X_{SSHA} is 0.3, and X_{DEPTH} is 0.1;
Case 2: X_{SST} is 0.5, X_{SSHA} is 0.2, and X_{DEPTH} is 0.3;
Case 3: X_{SST} is 0.4, X_{SSHA} is 0.2, and X_{DEPTH} is 0.4;
Case 4: X_{SST} is 0.3, X_{SSHA} is 0.4, and X_{DEPTH} is 0.3;
Case 5: X_{SST} is ⅓, X_{SSHA} is ⅓, and X_{DEPTH} is ⅓;
an optimal weight case for forecasting the central fishery is obtained by comparing the HSI values in the five different weight cases with a set threshold respectively.

### Advantages

The impact of environmental factors of different weights on the northwest African waters cephalopod habitat model is discussed according to the production statistical data of a fishery company in combination with satellite remote sensing data, and main environmental factors affecting the distribution of cephalopod habitats and an optimal weight case are obtained to provide a basis for forecasting the central fishery of cephalopods in northwest African waters.

### BRIEF DESCRIPTION OF THE DRAWINGS

FIG. 1 is a flow diagram of a fishery forecasting method according to the present invention.

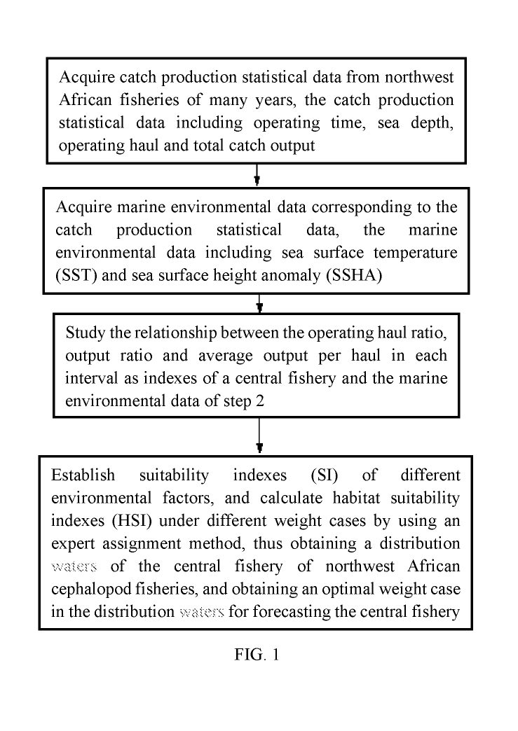

FIG. 2 is a flow diagram of a Moroccan waters cephalopod fishery forecasting method according to Embodiment 1 of the present invention.

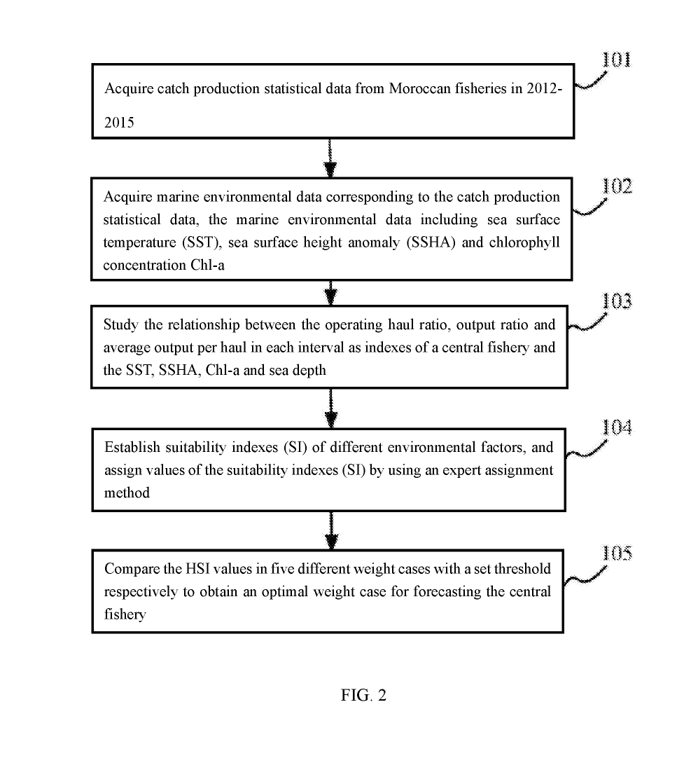

FIG. 3 is a flow diagram of a Mauritanian waters cephalopod fishery forecasting method according to Embodiment 2 of the present invention.

### DETAILED DESCRIPTION OF THE EMBODIMENTS

The present invention is further illustrated below in combination with specific embodiments and drawings.

Cephalopods are annual species, and the fishery situation and the resource abundance thereof are closely related to the marine environment, so climate changes and different marine environments directly affect the habitat and resource abundance of the cephalopods, and then affect the fishery production and scientific management. Therefore, it is extremely important to study the main environmental factors affecting the distribution of cephalopod habitats. The use of environmental factors to establish a fishery prediction model can scientifically guide the production of cephalopods in northwest African waters, and also guides the efficient catch production of related enterprises in the waters.

### Embodiment 1

For the Moroccan waters in the Atlantic Ocean, the main environmental factors affecting the distribution of cephalopod habitats are obtained by research through the following steps.

Step 101: Acquire catch production statistical data from Moroccan fisheries in 2012-2015, the catch production statistical data including operating time, longitude, latitude, sea depth, operating haul and output.

The catch production statistical data from Moroccan fisheries is from Shanghai Deep-Ocean Fishery Company.

Step 102: Acquire marine environmental data corresponding to the catch production statistical data, the marine environmental data including sea surface temperature (SST), sea surface height anomaly (SSHA) and chlorophyll concentration Chl-a, based on a monthly time resolution and a 0.5°×0.5° spatial resolution, from January to May and from November to December in 2012-2015.

Step 103: Study the relationship between the operating haul, the operating output ratio and the average output per haul in each interval as indexes of a central fishery and the SST, SSHA, Chl-a and sea depth.

1) Calculate the operating haul, the operating output ratio and the average output per haul in each interval of 1° C. of SST to obtain an optimal SST range of the central fishery;
2) Calculate the operating haul, the operating output ratio and the average output per haul in each interval of 10 cm of SSHA to obtain an optimal SSHA range of the central fishery;
3) Calculate the operating haul, the operating output ratio and the average output per haul in each interval of 0.01-1.0, 1.0-2.0, 2.0-5.0, 5.0-20.0 or 20.0-50.0 mg/m³ of Chl-a content to obtain an optimal Chl-a range of the central fishery;
4) Calculate the operating haul, the operating output ratio and the average output per haul in each interval of 10 cm of sea depth to obtain an optimal sea depth range of the central fishery.

Step 104: Establish suitability indexes SI of different environmental factors, assign values to the suitability indexes SI by using an expert assignment method, and set waters having the highest distribution probability of the central fishery as waters with the maximum operating haul, the suitability index SI of which is assigned with 1; when there is no operating haul, assign the suitability index SI with 0; when the operating haul is higher than the average, assign the suitability index SI with 0.5; and when the operating haul is lower than the average, assign the suitability index SI with 0.1.

The fishing vessel generally determines a fishery based on the experience of a captain and the images of a fish finder. Therefore, the operating haul can be regarded as an indicator of discovering fish, and is used to indicate the suitability index of a habitat.

TABLE 1
Determination criteria for habitat suitability index

| Number | Suitability index value | Description of habitat use |
|---|---|---|
| 1 | 1.0 | Waters having the highest |
| 2 | 0.5 | operating haul |
| 3 | 0.1 | Waters having the operating haul |
| 4 | 0.0 | above the average |
| | | Waters having the operating haul |
| | | below the average |
| | | Waters having 0 operating haul |

Step 105: Calculate habitat suitability indexes HSI under five different weight cases by using the following formula:

HSI=X_{SST}*I_{SI_SST}+X_{SSHA}*I_{SI_SSHA}+X_{CHL-a}*I_{SI-CHL-a}+X_{DEPTH}*I_{SI_DEPTH}

Calculate the changes of habitat suitability indexes (HSI) from 0 to 1 under different weights of relevant marine environmental factors. The area where the HSI is more than 0.6 is generally regarded as the waters where the central fishery is distributed.

In the formula: I_{SI_SST}, I_{SI_SSHA}, I_{SI-CHL-a} and I_{SI_DEPTH} are respectively suitability indexes based on sea surface temperature, sea surface height anomaly, chlorophyll concentration and sea depth. X_{SST}, X_{SSHA}, X_{CHL-a} and X_{DEPTH} are weight values of sea surface temperature, sea surface height anomaly, chlorophyll concentration and sea depth. Totally five different cases of different weights are provided, as shown in Table 2 below.

TABLE 2
Weight values based on different
environmental factors related to the central fishery

| Case | SST | SSHA | CHL-a | DEPTH |
|---|---|---|---|---|
| 1 | 0.25 | 0.25 | 0.25 | 0.25 |
| 2 | 0 | 0.9 | 0 | 0.1 |
| 3 | 0.1 | 0.1 | 0 | 0.8 |
| 4 | 0.9 | 0.1 | 0 | 0 |
| 5 | 0.4 | 0.4 | 0.1 | 0.1 |

The HSI values in the five different weight cases are compared with a set threshold respectively to obtain an optimal weight case for forecasting the central fishery of Moroccan cephalopod fisheries. Different weight cases are compared using the statistical data from January to March and from November to December in 2012-2015, the HSI values being 0-0.2, 0.2-0.4, 0.4-0.6, 0.6-0.8, and 0.8-1.0. On this basis, statistical analysis is performed on the HSI value >0.6 and the HSI value <0.4 in the five different weight cases to obtain an optimal weight case for forecasting the central fishery.

According to the above method, the following analysis is based on specific statistical data:

### 1. Analysis of Production Status

### 1) Relationship Between Fishery Distribution and Sea Surface Temperature (SST)

The analysis results show that the distribution of cephalopod fisheries is closely related to the sea surface temperature, and different months have different suitable SST ranges. In January, the operation is mainly in the waters having the SST range of 16˜19° C., the suitable SST range for high average output per haul is 16-17° C. and 18-19° C., and the average output is 130-153 kg. In February, the operation is mainly in the waters having the SST range of 15˜19° C., the suitable SST range for high average output per haul is 16˜17° C. and 18˜19° C., and the average output is 122˜147 kg. In March, the operation is mainly in the waters having the SST range of 15˜17° C., the suitable SST range for high average output per haul is 15˜16° C., and the average output is 89.16 kg. In November, the operation is mainly in the waters having the SST range of 18˜23° C., the suitable SST range for high average output per haul is 19˜23° C., and the average output is 162˜185 kg. In December, the operation is mainly in the waters having the SST range of 16˜21° C., the suitable SST range for high average output per haul is 20˜21° C., and the average output is 457 kg.

### 2) Relationship Between Fishery Distribution and SSHA

The analysis results show that the distribution of cephalopod fisheries is closely related to the sea surface height anomaly, and different months have different suitable SSHA ranges. In January, the operation is mainly in the waters having the SSHA range of −60˜−20 cm, the suitable SSHA range for high average output per haul is −60˜−30 cm, and the average output is 124˜185 kg. In February, the operation is mainly in the waters having the SSHA range of −60˜−30 cm, the suitable SSHA range for high average output per haul is −60˜−40 cm, and the average output is 123˜137 kg. In March, the operation is mainly in the waters having the SSHA range of −60˜−30 cm, the suitable SSHA range for high average output per haul is −60˜−40 cm, and the average output is 96˜101 kg. In November, the operation is mainly in the waters having the SSHA range of −50˜10 cm, the suitable SSHA range for high average output per haul is −40˜−30 and −10˜0 cm, and the average output is 189˜209 kg. In December, the operation is mainly in the waters having the SSHA range of −50˜10 cm, the suitable SSHA range for high average output per haul is −50˜−40 cm, and the average output is 558.69 kg.

### 3) Relationship Between Fishery Distribution and Chlorophyll Concentration

The analysis results show that the distribution of cephalopod fisheries is closely related to the chlorophyll concentration, and different months have different suitable chlorophyll concentration ranges. In January, the operation is mainly in the waters having the Chl-a range of 0.01˜50 mg/m³, the suitable Chl-a range for high average output per haul is 1.0˜5.0 mg/m³, and the average output is 96˜127 kg. In February, the operation is mainly in the waters having the Chl-a range of 0.01˜20 mg/m³, the suitable Chl-a range for high average output per haul is 1.0˜20.0 mg/m³, and the average output is 119˜128 kg. In March, the operation is mainly in the waters having the Chl-a range of 0.01˜50 mg/m³, the suitable Chl-a range for high average output per haul is 1.0˜2.0 and 5.0˜50 mg/m³, and the average output is 99˜110 kg. In November, the operation is mainly in the waters having the Chl-a range of 0.01˜20 mg/m³, the suitable Chl-a range for high average output per haul is 0.01˜5.0 mg/m³, and the average output is 169˜176 kg. In December, the operation is mainly in the waters having the Chl-a range of 0.01˜50 mg/m³, the suitable Chl-a range for high average output per haul is 2.0˜5.0 mg/m³, and the average output is 256.24 kg.

### 4) Relationship Between Fishery Distribution and Sea Depth

The analysis results show that the distribution of cephalopod fisheries is closely related to the sea depth, and different months have different suitable sea depth ranges. In January, the operation is mainly in the waters having the sea depth range of 20˜90 m, the suitable sea depth range for high average output per haul is 20˜40 m, and the average output is 131˜140 kg. In February, the operation is mainly in the waters having the sea depth range of 20˜100 m, the suitable sea depth range for high average output per haul is 20˜50 m and 60˜70 m, and the average output is 117˜141 kg. In March, the operation is mainly in the waters having the sea depth range of 20˜80 m, the suitable sea depth range for high average output per haul is 70˜80 m, and the average output is 169 kg. In November, the operation is mainly in the waters having the sea depth range of 30˜80 m, the suitable sea depth range for high average output per haul is 30˜40 m, and the average output is 246.49 kg. In December, the operation is mainly in the waters having the sea depth range of 20˜80 m, the suitable sea depth range for high average output per haul is 20˜50 m, and the average output is 217˜283 kg.

### 2. Suitability Index (SI) Establishment

Suitability indexes (Table 3) based on SST, SSHA, Chl-a and seabed sea depth in each month are respectively established according to Table 1. According to Table 3, the SST, SSHA, Chl-a and sea depth for highest SI in January are respectively 17˜18° C., −50˜−40 cm, 2.0˜5.0 mg/m³ and 30˜40 m; the SST, SSHA, Chl-a and sea depth for highest SI in February are respectively 16˜17° C., −50˜−40 cm, 2.03˜5.0 mg/m³ and 30˜40 m; the SST, SSHA, Chl-a and sea depth for highest SI in March are respectively 16˜17° C., −50˜−40 cm, 2.0˜5.0 mg/m³ and 20˜30 m; the SST, SSHA, Chl-a and sea depth for highest SI in November are respectively 19˜20° C., 0˜10 cm, 0.01˜1.0 mg/m³ and 60˜70 m; and the SST, SSHA, Chl-a and sea depth for highest SI in December are respectively 18˜19° C., −40˜−30 cm, 2.0˜5.0 mg/m³ and 60˜70 m. The optimal SST, SSHA, Chl-a and sea depth vary from month to month.

TABLE 3
Suitability indexes based on SST, SSHA, Chl-a
and seabed sea depth in each month

| | | | | ρChl- | |
|---|---|---|---|---|---|
| Month | SI | SST/° C. | SSHA/cm | a/(mg/m³) | Sea depth/m |
| January | 1.0 | 17~18 | −50~−40 | 2.0~5.0 | 30~40 |
| | 0.5 | 16~17 | −30~−20 | 1.0~2.0 | 60~70 |
| | 0.1 | 18~19 | −60~−50, | 0.01~1.0, | 20~30, |
| | | | | | 80~90 |
| | 0.0 | <16, | −40~−30 | 5.0~50 | <20, |
| | | >19 | <−60, | <0.01, | 40~60, |
| | | | >−20 | >50 | 70~80, |
| | | | | | >90 |
| February | 1.0 | 16~17 | −50~−40 | 2.0~5.0 | 30~40 |
| | 0.5 | 15~16 | −40~−30 | 1.0~2.0 | 60~70 |
| | 0.1 | 18~19 | −60~−50 | 0.01~1.0, | 20~30, |
| | | | | | 40~60, |
| | 0.0 | <15, | <−60, | 5.0~20 | 70~100 |
| | | 17~18, | >−30 | <0.01, | <20, |
| | | >19 | | >20 | >100 |
| March | 1.0 | 16.20~16.39 | −50~−40 | 2.0~5.0 | 20~30 |
| | 0.5 | 16.00~16.19 | −60~−50 | 0.01~1.0 | 30~40 |
| | 0.1 | 15.00~15.39 | −40~−30 | 1.0~2.0, | 40~80 |
| | 0.0 | <15, | <−60, | 5.0~50 | <20, |
| | | 15.40~15.99, | >−30 | <0.01, | >80 |
| | | >16.40 | | >50 | |
| November | 1.0 | 19~20 | 0~−10 | 0.01~1.0 | 60~70 |
| | 0.5 | 20~22 | −40~−30 | 1.0~2.0 | 30~40 |
| | 0.1 | 18~19, | −50~−40, | 2.0~20 | 40~60, |
| | | 22~23 | −30~−20, | | 70~80 |
| | 0.0 | <18, | −10~0 | <0.01, | <30, |
| | | >23 | <−50, | >20 | >80 |
| | | | −20~−10, | | |
| | | | >10 | | |
| December | 1.0 | 18~19 | −40~−30 | 2.0~5.0 | 60~70 |
| | 0.5 | 19~20 | −30~−20, | 1.0~2.0 | 20~40 |
| | | | 0~10 | | |
| | 0.1 | 16~18, | −50~−40, | 0.01~1.0, | 40~60, |
| | | 20~21 | −10~0 | | 70~80 |
| | 0.0 | <16, | <−50, | 5.0~50 | <20, |
| | | >21 | −20~−10, | <0.01, | >80 |
| | | | >10 | >50 | |

### 3. Comparison of Weight Cases Based on Correlation Factors of Habitat Suitability Indexes (HSI)

Through the habitat suitability indexes of the weight values set based on different environmental factors related to the central fishery (Table 3), the haul ratio, output ratio and average output per haul from January to March and from November to December in 2012-2015 are summarized according to different HSIs to obtain averages of the five cases (Table 4).

It can be seen from Table 4 that among the five cases, the haul ratio and the output ratio of Case 3 are smallest, respectively 42.97% and 38.53%, and the average output per haul is only 130.17 kg compared with other cases. Therefore, the weight setting of Case 3 is worst. The values obtained in Case 2 and Case 4 are similar and lower than Case 1 and Case 5 (Table 4), so Case 2 and Case 4 are also inferior. In Case 1 and Case 5, the haul ratio and the output ratio in which the HSI is more than 0.6 are relatively close, respectively 59.69% and 60.2% in Case 1, and 58.38% and 60.96% in Case 5. However, it can be discovered by comparison in Table 5 that Case 5 has better average output per haul and haul and output ratios in which the HSI is more than 0.8 than Case 1, so the weight setting in Case 5 is optimal.

TABLE 4
Average of monthly haul ratio, output ratio
and average output per haul in five cases

| | Case 1 | | | Case 2 | | | | |
|---|---|---|---|---|---|---|---|---|
| | | | Average | | | Average | Case 3 | |
| | Haul | Output | output per | Haul | Output | output per | Haul | Output |
| HSI | ratio/% | ratio/% | haul/kg | ratio/% | ratio/% | haul/kg | ratio/% | ratio/% |
| 0.8~ | 14.9 | 13.5 | 131. | 49.8 | 52.1 | 151. | 35.9 | 30.3 |
| 1.0 | 4 | 6 | 79 | 5 | 0 | 76 | 2 | 6 |
| 0.6~ | 44.7 | 46.6 | 151. | 0 | 0 | 0 | 7.05 | 8.17 |
| 0.8 | 5 | 4 | 32 | 25.9 | 23.8 | 133. | 22.2 | 28.3 |
| 0.4~ | 22.2 | 22.1 | 144. | 0 | 3 | 57 | 9 | 2 |
| 0.6 | 9 | 3 | 14 | 0 | 0 | 0 | 16.8 | 15.7 |
| 0.2~ | 2.31 | 2.65 | 166. | 13.5 | 13.5 | 145. | 9 | 3 |
| 0.4 | 0.47 | 0.67 | 13 | 2 | 7 | 77 | 7.11 | 6.92 |
| 0.0~ | | | 205. | | | | | |
| 0.2 | | | 38 | | | | | |

| | Case 3 | Case 4 | | | Case 5 | | |
|---|---|---|---|---|---|---|---|
| | Average | | | Average | | | Average |
| | output per | Haul | Output | output per | Haul | Output | output per |
| HSI | haul/kg | ratio/% | ratio/% | haul/kg | ratio/% | ratio/% | haul/kg |
| 0.8~ | 122. | 51.5 | 45.7 | 128. | 29.9 | 27.7 | 134. |
| 1.0 | 70 | 1 | 2 | 87 | 3 | 7 | 71 |
| 0.6~ | 168. | 0 | 0 | 0 | 28.4 | 33.1 | 169. |
| 0.8 | 20 | 29.0 | 36.1 | 180. | 5 | 9 | 36 |
| 0.4~ | 184. | 5 | 7 | 82 | 20.8 | 17.4 | 121. |
| 0.6 | 47 | 0 | 0 | 0 | 7 | 2 | 25 |
| 0.2~ | 135. | 8.83 | 7.69 | 126. | 4.92 | 5.84 | 172. |
| 0.4 | 23 | | | 43 | 0.59 | 1.42 | 33 |
| 0.0~ | 141. | | | | | | 347. |
| 0.2 | 32 | | | | | | 60 |

Moroccan cephalopod habitat models under different weights were studied according to the production statistical data of a deep-ocean fishing company in Shanghai from 2012 to 2015 in combination with sea surface temperature (SST), sea surface height anomaly (SSHA), chlorophyll mass concentration (CHL-a) and sea depth data.

The studies show that the distribution of Moroccan cephalopod habitats is closely related to the environmental factors such as sea surface temperature, sea surface height anomaly and sea depth, and the monthly suitable environmental factors are different; the SST range in the fishery distribution area is 15˜23° C., the SSHA range is −60˜10 cm, the chlorophyll concentration is 0˜50 mg/m³, and the sea depth range is 20˜100 m, wherein the most suitable SST is 16˜18 and 19˜20° C., the most suitable SSHA is −50˜−30 cm, the most suitable chlorophyll content is 1.0˜5.0 mg/m³, and the most suitable sea depth is 30˜40 and 60˜70 m. According to the model analysis, the weights of Case 5 are optimal, and the weight factors of SST, SSHA, CHL-a and sea depth are respectively 0.4, 0.4, 0.1 and 0.1, indicating that SST and SSHA have the greatest influence in the habitat index model, followed by sea depth, then chlorophyll.

### Embodiment 2

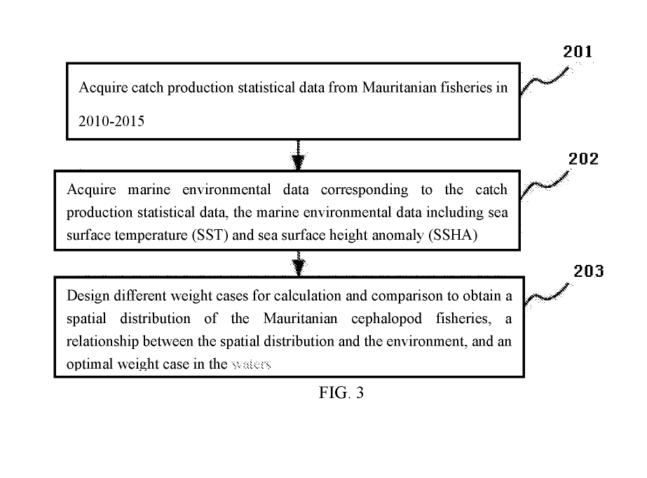

As shown in FIG. 3, the present embodiment provides a Mauritanian cephalopod fishery forecasting method based on habitat indexes, including the following steps:

Step 101: acquire catch production statistical data from Mauritanian fisheries in 2010-2015, the catch production statistical data including operating time, operating sea depth, haul and total catch output.

The catch production statistical data is from a deep-ocean fishery company having more than 10 trawlers in 2010-2015. Since May and June are often fishing off seasons, the production statistics are from January to April and July to December every year.

Step 2: acquire marine environmental data corresponding to the catch production statistical data, the marine environmental data including sea surface temperature (SST) and sea surface height anomaly (SSHA), based on a monthly time resolution and a 0.5°×0.5° spatial resolution, from January to April and from July to December of 2010-2015.

Step 103: collect statistics on the operating haul, the sea depth and the total catch output of different time periods in each month of 2010-2015, screen, sort and summarize the statistical data, establish a suitability index using the average output per haul as a central fishery index and using an expert assignment method, and then design different weight cases for chart calculation and comparison to obtain a spatial distribution of Mauritanian cephalopod fisheries, a relationship between the spatial distribution and the marine environment, and an optimal weight case in the corresponding waters of the Mauritanian cephalopod fisheries, wherein the relationship is the optimal SST, SSHA and sea depth range for a central fishery.

Specifically, the method includes the following steps:

### 1. Analysis on a Relationship Between Fishery Distribution and Environmental Factors

A frequency distribution map is drawn to understand and grasp the relationship between the production value, operating haul, average output per haul and various environmental factors, and obtain the overall environmental factors of fishery distribution in the fishing season and the optimal intervals, the maximum and minimum values of the environmental factors (sea surface temperature, sea surface height and sea depth) are found, and the fisheries are divide into intervals.

average output per haul=total output/operating haul (kg) Formula:

The relationship between the total catch haul, total catch output, average output per haul and the sea surface temperature (SST), sea surface height anomaly (SSHA), and sea depth:

Statistics on monthly total catch haul, total output and days are collected based on SST minimum 15° C., SSHA minimum −45 cm, sea depth minimum 15 m and corresponding intervals 1° C., 10 cm and 10 m, a catch haul ratio, an output ratio and an average output per haul at intervals of SST 1° C., SSHA 10 cm and sea depth 10 m are solved, and therefore an optimal sea surface temperature interval, an optimal sea surface height anomaly interval and an optimal sea depth interval of the central fishery in each month are obtained.

### 2. Establishment of Suitability Indexes

Based on a frequency distribution map of the operating haul, suitability indexes SI of different environmental factors are established, values of the suitability indexes SI are assigned using an expert assignment method, waters with the maximum operating haul NETmax are set as waters with the highest catch distribution probability, and the suitability index SI is assigned with 1; when there is no operating haul, the suitability index SI is assigned with 0; when the operating haul is higher than the average the suitability index SI is assigned with 0.5; and when the operating haul is lower than the average, the suitability index SI is assigned with 0.1. See Table 5:

TABLE 5
Determination criteria for suitability indexes

| Number | Suitability index value | Description of habitat use |
|---|---|---|
| 1 | 1 | Waters having the highest operating |
| 2 | 0.5 | haul |
| 3 | 0.1 | Waters having the operating haul |
| 4 | 0 | higher than the average |
| | | Waters having the operating haul |
| | | lower than the average |
| | | Waters having 0 operating haul |

### 3. Establishment of Habitat Suitability Index

HSI (Habitat suitability index) ranges from 0 to 1, based on the suitability index of each environmental factor.

TABLE 6
Five different weight cases

| Case | X_{SST} | X_{SSHA} | X_{DEPTH} |
|---|---|---|---|
| 1 | 0.6 | 0.3 | 0.1 |
| 2 | 0.5 | 0.2 | 0.3 |
| 3 | 0.4 | 0.2 | 0.4 |
| 4 | 0.3 | 0.4 | 0.3 |
| 5 | 1/3 | 1/3 | 1/3 |

Xₛₛₜ indicates the weight of the sea surface temperature, X_{SSHA} indicates the weight of the sea surface height anomaly; X_{DEPTH} indicates the weight of the sea depth.

Habitat suitability indexes (HSI) are calculated under five different weight cases by using the formula HSI=X_{SST}*I_{SI_SST}+X_{SSHA}*I_{SI_SSHA}+X_{DEPTH}*I_{SI_DEPTH}, in which: I_{SST} indicates a suitability index based on sea surface temperature; I_{SSHA} indicates a suitability index based on sea surface height anomaly; I_{SI_DEPTH} indicates a suitability index based on sea depth.

### 4. Comparison of Five Different Weight Cases

Different weight cases are compared using the statistical data from 2010 to January to March, July and September in 2015, the HSI values being 0˜0.2, 0.2˜0.4, 0.4˜0.6, 0.6˜0.8, and 0.8˜1.0. On this basis, statistical analysis is performed on the HSI value >0.6 and the HSI value <0.4 in the five different weight cases to obtain an optimal weight case for forecasting the central fishery.

According to the above method, the following analysis is based on specific statistical data:

### 1. Analysis of Production Status

### 1) Relationship Between Fishery Distribution and Sea Surface Temperature

The analysis results show that the distribution of northwestern African waters cephalopod fisheries is closely related to the sea surface temperature, and different months have different suitable SST ranges. From January to April, the main SSTs of fishing grounds are respectively 16˜20° C., 16˜19° C., 16˜19° C., 17˜18° C.; the suitable SSTs for high average outputs per haul are respectively 15˜21° C., 15˜19° C. and 20˜21° C., 15˜20° C., 17˜20° C., and the corresponding high average outputs per haul are respectively 34˜51 kg, 30˜43 kg, 26˜37 kg, 26˜30 kg. From July to December, the main SSTs of fishing grounds are respectively 20˜21° C., 21˜22° C. and 23˜26° C., 25˜27° C., 21˜22° C., 19˜21° C., 20˜21° C. and 23˜24° C.; the suitable SSTs for high average outputs per haul are respectively 20˜22° C., 21˜24° C., 24˜27° C., 20˜22° C., 18˜21° C., 20˜22° C. and 23˜24° C., and the high average outputs per haul are respectively 77˜92 kg, 54˜63 kg, 29˜34 kg, 99˜103 kg, 36˜52 kg, 31˜47 kg.

### 2) Relationship Between Fishery Distribution and Sea Surface Height Anomaly

The analysis results show that the distribution of cephalopod fisheries is closely related to the sea surface height anomaly, and different months have different suitable SSHA ranges. From January to April, the main SSHAs of fishing grounds are respectively −35˜−25 cm and −5˜5 cm, −45˜−35 cm and −5˜5 cm, −5˜5 cm, −5˜5 cm; the suitable SSHAs for high average outputs per haul are respectively −40˜−20 cm, −50˜−30 cm, −45˜−35 cm, −5˜15 cm, and the corresponding high average outputs per haul are respectively 37˜47 kg, 47˜48 kg, 59.22 kg, 28˜35 kg. From July to December, the main SSHAs of fishing grounds are respectively −35˜25 cm and −25˜−15 cm, −35˜−25 cm and −5˜5 cm, −35˜−25 cm, −25˜−15 cm, −5˜5 cm; the suitable SSHAs for high average outputs per haul are respectively −45˜−15 cm, −45˜−15 cm, −35˜−15 cm and −5˜5 cm, −35˜−15 cm, −35˜−15 cm and −5˜5 cm, −5˜5 cm, and the corresponding high average outputs per haul are respectively 67˜80 kg, 48˜56 kg, 27˜40 kg, 81˜104 kg, 42˜50 kg, 36.96 kg.

### 3) Relationship Between Fishery Distribution and Sea Depth

The analysis results show that the distribution of cephalopod fisheries is closely related to the sea depth, and different months have different suitable sea depth ranges. From January to April, the main sea depths of fishing grounds are respectively 45˜65 m, 55˜75 m, 55˜85 m, 65˜75 m and 85˜95 m; the suitable sea depths for high average outputs per haul are respectively 55˜65 m, 45˜75 m, 55˜85 m, 85˜95 m, and the corresponding high average outputs per haul are respectively 44.32 kg, 30˜43 kg, 28˜38 kg, 31.96 kg. From July to December, the main sea depths of fishing grounds are respectively 15˜25 m, 15˜25 m and 45˜55 m, 55˜75 m, 55˜65 m, 55˜65 m, 25˜35 m and 45˜55 m; the suitable sea depths for high average outputs per haul are respectively 15˜25 m and 55˜75 m, 15˜25 m, 45˜75 m, 55˜65 m, 55˜65 m, 25˜35 m and 45˜55 m, and the corresponding high average outputs per haul are respectively 58˜77 kg, 57.43 kg, 27˜39 kg, 99.62 kg, 45.12 kg, 36˜38 kg.

### 2. Suitability Index (SI)

According to Table 7, the SST, SSHA and sea depth for maximum SI in January are respectively 16˜17° C., −5˜5 cm and 55˜65 m; the SST, SSHA and sea depth for maximum SI in February are respectively 16˜17° C., −5˜5 cm and 65˜75 m; the SST, SSHA and sea depth for maximum SI in March are respectively 18˜19° C., −5˜0 cm and 75˜85 m; the SST, SSHA and sea depth for maximum SI in July are respectively 20˜21° C., −30˜−25 cm and 20˜25 m; and the SST, SSHA and sea depth for maximum SI in September are respectively 26˜27° C., −5˜5 cm and 55˜65 m.

TABLE 7
Suitability indexes based on sea surface temperature, sea surface height
anomaly and sea depth in January to March, July and September

| Month | SI value | SST/° C. | SSHA/cm | Sea depth/m |
|---|---|---|---|---|
| January | 1.0 | 16~17 | −5~−5 | 55~65 |
| | 0.5 | 17~20 | −35~−25 | 45~55 |
| | 0.1 | 15~16, | −25~−5 | 35~45 |
| | | 20~22 | | |
| | 0 | <15, | <−35, | <35, |
| | | >22 | >5 | >65 |
| February | 1.0 | 16~17 | −5~−5 | 65~75 |
| | 0.5 | 17~19 | −45~−35 | 55~65 |
| | 0.1 | 15~16, | −35~−25, | 45~55 |
| | | 19~21 | 5~−15 | |
| | 0 | <15, | <−45, | <45, |
| | | >21 | −25~−5, | >75 |
| | | | >15 | |
| March | 1.0 | 18~19 | −5~0 | 75~85 |
| | 0.5 | 17~18 | 0~5 | 55~65 |
| | 0.1 | 15~17, | −40~−35 | 65~75, |
| | | 19~20 | | 85~95 |
| | 0 | <15, | <−40, | <55, |
| | | >20 | −35~−5, | >95 |
| | | | >5 | |
| July | 1.0 | 20~21 | −30~−25 | 20~25 |
| | 0.5 | 21~22 | −40~−30 | 15~20 |
| | 0.1 | 19~20, | −45~−40, | 60~75 |
| | | 22~24 | −25~−20 | |
| | 0 | <19, | <−45, | <15, |
| | | >24 | >−20 | 25~60, |
| | | | | >75 |
| September | 1.0 | 26~27 | −5~−5 | 55~65 |
| | 0.5 | 25~26 | −35~−25 | 65~75 |
| | 0.1 | 24~25, | −25~−15, | 45~55 |
| | | 27~28 | 5~15 | |
| | 0 | <24, | <−35, | <45, |
| | | >28 | −15~−5, | >75 |
| | | | >15 | |

### 3. Comparison of Weight Cases Based on Correlation Factors of Habitat Suitability Index (HSI)

When the HSI is more than 0.6, it is generally the central fishery. At this time, if the operating haul ratio and the output ratio are larger, the corresponding weight case model is better. It can be seen from Table 8 that Case 1 is optimal, in which the HSI value is more than 0.6, the operating haul ratio and the output ratio are respectively 64.2826 and 67.6196, and the average output per haul is 44˜51 kg; Case 5 is worst, in which the HSI value is more than 0.6, the operating haul ratio and the output ratio are respectively 57.8826 and 61.92%, and the average output per haul is 45˜48 kg. Table 8 analyzes the operating haul, the operating output ratio and the average output per haul in January to March, July and September of 2010-2015 based on habitat index models of five cases.

| | Case 1 | | | Case 2 | | | | |
|---|---|---|---|---|---|---|---|---|
| | | | Average | | | Average | Case 3 | |
| | Haul | Output | output per | Haul | Output | output per | Haul | Output |
| HSI | ratio/% | ratio/% | haul/kg | ratio/% | ratio/% | haul/kg | ratio/% | ratio/% |
| 0~0.2 | 4.80 | 4.90 | 44.41 | 2.49 | 2.87 | 50.05 | 2.49 | 2.87 |
| 0.2~0.4 | 12.54 | 10.82 | 37.51 | 9.44 | 8.08 | 37.20 | 8.75 | 7.73 |
| 0.4~0.6 | 18.39 | 16.67 | 39.41 | 27.91 | 24.28 | 37.81 | 27.97 | 23.08 |
| 0.6~0.8 | 32.67 | 31.20 | 41.52 | 34.59 | 35.16 | 44.19 | 26.33 | 27.72 |
| 0.8~1 | 31.61 | 36.41 | 50.06 | 25.58 | 29.61 | 50.33 | 34.47 | 38.59 |

| | Case 3 | Case 4 | | | Case 5 | | |
|---|---|---|---|---|---|---|---|
| | Average | | | Average | | | Average |
| | output per | Haul | Output | output per | Haul | Output | output per |
| HSI | haul/kg | ratio/% | ratio/% | haul/kg | ratio/% | ratio/% | haul/kg |
| 0~0.2 | 50.05 | 2.49 | 2.87 | 50.05 | 2.49 | 2.87 | 50.05 |
| 0.2~0.4 | 38.43 | 10.87 | 9.02 | 36.05 | 10.19 | 8.68 | 37.02 |
| 0.4~0.6 | 35.87 | 28.76 | 26.20 | 39.60 | 29.45 | 26.54 | 39.18 |
| 0.6~0.8 | 45.78 | 25.35 | 26.49 | 45.42 | 25.35 | 26.49 | 45.42 |
| 0.8~1 | 48.67 | 32.52 | 35.42 | 47.34 | 32.52 | 35.42 | 47.34 |

The distribution of Mauritanian cephalopod fisheries and habitat index models thereof under different environmental weights are analyzed according to the production statistical data collected from Mauritanian fisheries in 2010-2015, in combination with sea surface temperature (SST), sea surface height anomaly (SSHA) and sea depth data acquired by satellite remote sensing, thereby providing a basis for forecasting Mauritanian cephalopod fisheries.

The studies show that the distribution of Mauritanian cephalopod fisheries is closely related to the marine environment, and the suitable environmental ranges of fishing grounds in January to April and July to December are also different to some extent. For the fishing grounds distributed in the waters with SST of 15˜28° C., SSHA of −45˜15 cm and sea depth of 15˜85 m, the optimal SST, SSHA and sea depth are respectively 16˜22° C., −35˜−25 cm and −5˜5 cm, 15˜25 m and 45˜75 m. Among the five Mauritanian cephalopod habitat model cases based on different weights, Case 1 is optimal (weights of SST, SSHA, and sea depth are respectively 0.6, 0.3, and 0.1), and Case 5 is worst (weights of SST, SSHA, and sea depth are all ⅓), that is, the models show that the impacts of different environmental factors on the formation of cephalopod fisheries are different, SST has the greatest impact, followed by SSHA, then the sea depth.

The impact of environmental factors of different weights on the northwest African waters cephalopod habitat model is discussed according to the production statistical data of a fishery company in combination with satellite remote sensing data, and main environmental factors affecting the distribution of cephalopod habitats and an optimal weight case are obtained to provide a basis for forecasting the central fishery of cephalopods in northwest African waters.

Although the specific embodiments of the present invention are described above, it should be understood by those skilled in the art that these embodiments are only exemplary, and the scope of the present invention is defined by the appended claims. Many changes or modifications may be made to these embodiments by those skilled in the art without departing from the spirit and scope of the present invention, and these changes and modifications fall within the scope of the present invention.

1. A cephalopod fishery forecasting method in northwest African waters based on environmental factors, comprising the following steps:
step 1: acquiring catch production statistical data from cephalopod fisheries in northwest African waters of a plurality of years, the catch production statistical data including an operating time, an operating sea depth, an operating haul and a total catch output;
step 2: acquiring marine environmental data corresponding to the catch production statistical data, the marine environmental data including a sea surface temperature (SST) and a sea surface height anomaly (SSHA), based on a monthly time resolution and a 0.5°×0.5° spatial resolution;
step 3: studying a relationship between the operating haul, the operating output ratio and an average output per haul in each interval as indexes of a central fishery and the marine environmental data of the step 2; and
step 4: establishing a suitability indexes (SI) of different environmental factors, calculating habitat suitability indexes (HSI) under different weight cases by using an expert assignment method, and obtaining distribution waters of the central fishery of cephalopod fisheries in northwest African waters, and obtaining an optimal weight case in the distribution waters for forecasting the central fishery.

2. The cephalopod fishery forecasting method in northwest African waters based on environmental factors according to claim 1, wherein the catch production statistical data from the cephalopod fisheries in northwest African waters is data of 4-6 years.

3. The cephalopod fishery forecasting method in northwest African waters based on environmental factors according to claim 1, wherein for Moroccan fisheries in the northwest Africa, marine environmental data corresponding to the catch production statistical data is acquired, the marine environmental data includes the sea surface temperature (SST), the sea surface height anomaly (SSHA) and a chlorophyll concentration Chl-a; the operating haul, the operating output ratio and the average output per haul in each interval are calculated using 1° C. as an interval of the SST, and then an optimal SST range of the central fishery is obtained; the operating haul, the operating output ratio and the average output per haul in each interval are calculated using 10 cm as an interval of the SSHA, and then an optimal SSHA range of the central fishery is obtained; the operating haul, the operating output ratio and the average output per haul in each interval are calculated using 0.01-1.0, 1.0-2.0, 2.0-5.0, 5.0-20.0 or 20.0-50.0 mg/m³ as an interval of Chl-a content, and then an optimal Chl-a range of the central fishery is obtained; and the operating haul, the operating output ratio and the average output per haul in each interval are calculated using 10 m as an interval of sea depth, and then an optimal sea depth range of the central fishery is obtained.

4. The cephalopod fishery forecasting method in northwest African waters based on environmental factors according to claim 3, wherein the suitability indexes (SI) of different environmental factors are established for the marine environmental data including the sea surface temperature (SST), the sea surface height anomaly (SSHA) and the chlorophyll concentration Chl-a, and the habitat suitability indexes HSI under different weight cases are calculated using the following formula:
HSI=X_{SST}*I_{SI_SST}+X_{SSHA}*I_{SI_SSHA}+X_{CHL-a}*I_{SI-CHL-a}+X_{DEPTH}*I_{SI_DEPTH};
wherein, I_{SI_SST} indicates a suitability index based on the sea surface temperature; I_{SI_SSHA} indicates a suitability index based on the sea surface height anomaly; I_{SI-CHL-a} indicates a suitability index based on the chlorophyll concentration; I_{SI_DEPTH} indicates a suitability index based on the sea depth; and X_{SST}, X_{SSHA}, X_{CHL-a} and X_{DEPTH} indicate weight values of the sea surface temperature, the sea surface height anomaly, the chlorophyll concentration and the sea depth respectively.

5. The cephalopod fishery forecasting method in northwest African waters based on environmental factors according to claim 4, wherein waters with a highest operating haul are set as waters with a highest distribution probability of the central fishery, and the suitability index SI is assigned with 1; when there is no operating haul, the suitability index SI is assigned with 0; when the operating haul is higher than the average, the suitability index SI is assigned with 0.5; and when the operating haul is lower than the average, the suitability index SI is assigned with 0.1.

6. The cephalopod fishery forecasting method in northwest African waters based on environmental factors according to claim 4, wherein the following five weight cases are used for the weight values of the sea surface temperature, the sea surface height anomaly, the chlorophyll concentration and the sea depth:
Case 1: X_{SST} is 0.25, X_{SSHA} is 0.25, X_{CHL-a} is 0.25, and X_{DEPTH} is 0.25;
Case 2: X_{SST} is 0, X_{SSHA} is 0.9, X_{CHL-a} is 0, and X_{DEPTH} is 0.1;
Case 3: X_{SST} is 0.1, X_{SSHA} is 0.1, X_{CHL-a} is 0, and X_{DEPTH} is 0.8;
Case 4: X_{SST} is 0.9, X_{SSHA} is 0.1, X_{CHL-a} is 0, and X_{DEPTH} is 0;
Case 5: X_{SST} is 0.4, X_{SSHA} is 0.4, X_{CHL-a} is 0.1, and X_{DEPTH} is 0.1;
an optimal weight case for forecasting the central fishery of the Moroccan cephalopod fisheries is obtained by comparing the HSI values in the five different weight cases with a set threshold respectively.

7. The cephalopod fishery forecasting method in northwest African waters based on environmental factors according to claim 1, wherein statistics on monthly total catch haul, total output and days are collected for Mauritania fisheries in the northwest Africa based on SST minimum 15° C., SSHA minimum −45 cm, sea depth minimum 15 m and corresponding intervals 1° C., 10 cm and 10 m, then a catch haul ratio, an output ratio and an average output per haul at intervals of SST 1° C., SSHA 10 cm and sea depth 10 m are solved, and an optimal sea surface temperature interval, an optimal sea surface height anomaly interval and an optimal sea depth interval of the central fishery in each month are thus obtained.

8. The cephalopod fishery forecasting method in northwest African waters based on environmental factors according to claim 7, wherein the habitat suitability indexes (HSI) under different weight cases are calculated for the corresponding marine environmental data by adopting the following formula:
HSI=X_{SST}*I_{SI_SST}+X_{SSHA}*I_{SI_SSHA}+X_{DEPTH}*I_{SI_DEPTH};
wherein, I_{SI_SST} indicates a suitability index based on the sea surface temperature; I_{SI_SSHA} indicates a suitability index based on the sea surface height anomaly; I_{SI_DEPTH} indicates a suitability index based on the sea depth; X_{SST}, X_{SSHA} and X_{DEPTH} indicate weight values of the sea surface temperature, the sea surface height anomaly and the sea depth respectively.

9. The cephalopod fishery forecasting method in northwest African waters based on environmental factors according to claim 8, wherein based on a frequency distribution map of the operating haul, the suitability indexes SI of different environmental factors are established, the values of the suitability indexes SI are assigned using an expert assignment method, the maximum operating haul NETmax is set in waters with a highest catch distribution probability, and the suitability index SI is assigned with 1; when there is no operating haul, the suitability index SI is assigned with 0; when the operating haul is higher than the average, the suitability index SI is assigned with 0.5; and when the operating haul is lower than the average, the suitability index SI is assigned with 0.1.

10. The cephalopod fishery forecasting method in northwest African waters based on environmental factors according to claim 8, wherein the following five weight cases are used for the weight values of the sea surface temperature, the sea surface height anomaly and the sea depth:
Case 1: X_{SST} is 0.6, X_{SSHA} is 0.3, and X_{DEPTH} is 0.1;
Case 2: X_{SST} is 0.5, X_{SSHA} is 0.2, and X_{DEPTH} is 0.3;
Case 3: X_{SST} is 0.4, X_{SSHA} is 0.2, and X_{DEPTH} is 0.4;
Case 4: X_{SST} is 0.3, X_{SSHA} is 0.4, and X_{DEPTH} is 0.3;
Case 5: X_{SST} is ⅓, X_{SSHA} is ⅓, and X_{DEPTH} is ⅓;
an optimal weight case for forecasting the central fishery is obtained by comparing the HSI values in the five different weight cases with a set threshold respectively.

11. The cephalopod fishery forecasting method in northwest African waters based on environmental factors according to claim 3, wherein the catch production statistical data from the cephalopod fisheries in northwest African waters is data of 4-6 years.

12. The cephalopod fishery forecasting method in northwest African waters based on environmental factors according to claim 7, wherein the catch production statistical data from the cephalopod fisheries in northwest African waters is data of 4-6 years.
